(19) United States
(12) Patent Application Publication
(10) Pub. No.: US 2014/0154645 A1
(43) Pub. Date: Jun. 5, 2014

(54) DENTAL CONTAINER

(71) Applicant: JOSHUA JAMES CHEETHAM, WINDSOR (AU)

(72) Inventor: JOSHUA JAMES CHEETHAM, WINDSOR (AU)

(73) Assignee: SDI North America Inc., Bensenville, IL (US)

(21) Appl. No.: 14/092,752

(22) Filed: Nov. 27, 2013

(30) Foreign Application Priority Data
Nov. 30, 2012 (AU) 2012905260

(51) Int. Cl. A61C 5/06

(52) U.S. Cl. CPC A61C 5/068
USPC 433/215

(57) ABSTRACT

A dental container (10) comprising means for containing liquid and solid powder dental materials initially in separated condition. The liquid is contained in a receptacle (22) having an inner wall (26) with a relatively thin weakened section (28). A plunger (30) is mounted in an open outer end (24) of the receptacle (22) initially. The receptacle (22) is inserted at a proximal end of an outer central body (12) whilst a separable nose portion (18) is mounted at a distal end of the outer central body (12).

In use, the plunger 30 is used to rupture the wall (26) by hydraulic pressure or by means of a sharp projection (52) to cause the liquid to contact powder material held in a distal end of the outer central body (12) and the nose (18) for mixing to form a dental paste. The nose (18) is subsequently manually detached from the outer central body (12) so that the dental paste can be accessed for use.

The present invention relates to a dental container

It is known to hold dental materials in containers with separated components until required for use. Typically, at the time of use the components are contacted with one another and admixed to form a dental composition.

It has been found that known dental containers are difficult to use with relatively viscous dental materials.

The container of the present invention aims to overcome at least in part difficulties encountered with the use of relatively viscous dental materials in dental containers.

In accordance with one aspect of the present invention there is provided a dental container arranged to contain a liquid and a solid powder initially in separated condition comprising an outer central body having a proximal end and a distal end, a liquid receptacle having a closed inner end and an open outer end mounted at the proximal end of the outer central body and a separable nose portion mounted at the distal end of the outer body initially for mixing purposes but which is arranged to be manually separated from the remainder of the container after mixing, a plunger mounted in the open outer end of the liquid receptacle, the closed inner end of the liquid receptacle being formed by a wall having a weakened section, the distal end of the central body and the nose portion being arranged to contain solid powder material, the arrangement being such that depression of the plunger causes the wall of the liquid receptacle to be ruptured at the weakened section so that the liquid and the solid powder material are contacted for mixing together to form a dental paste.

The present invention will now be described, by way of example, with reference to the accompanying drawings, in which:

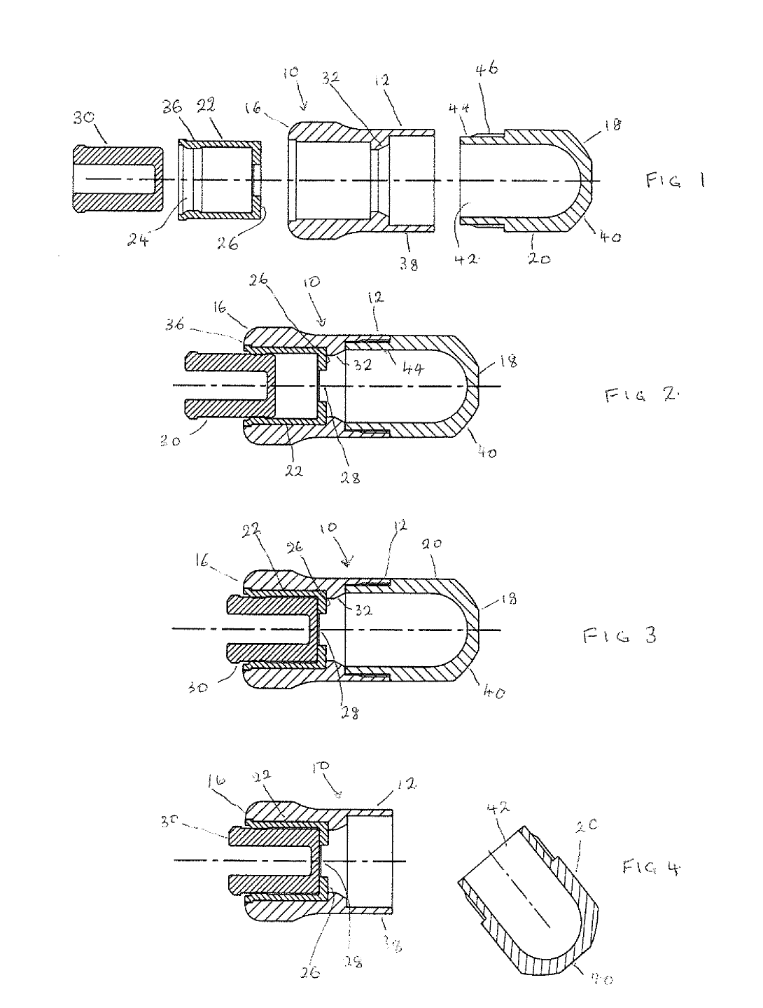

FIG. 1 is a longitudinal sectional view of a container in accordance with the present invention in exploded condition;

FIG. 2 is a view similar to FIG. 1 showing the container in assembled condition;

FIG. 3 is a view similar to FIG. 2 showing the container in activated condition;

FIG. 4 is a view similar to FIG. 3 showing the container in separated condition after activation;

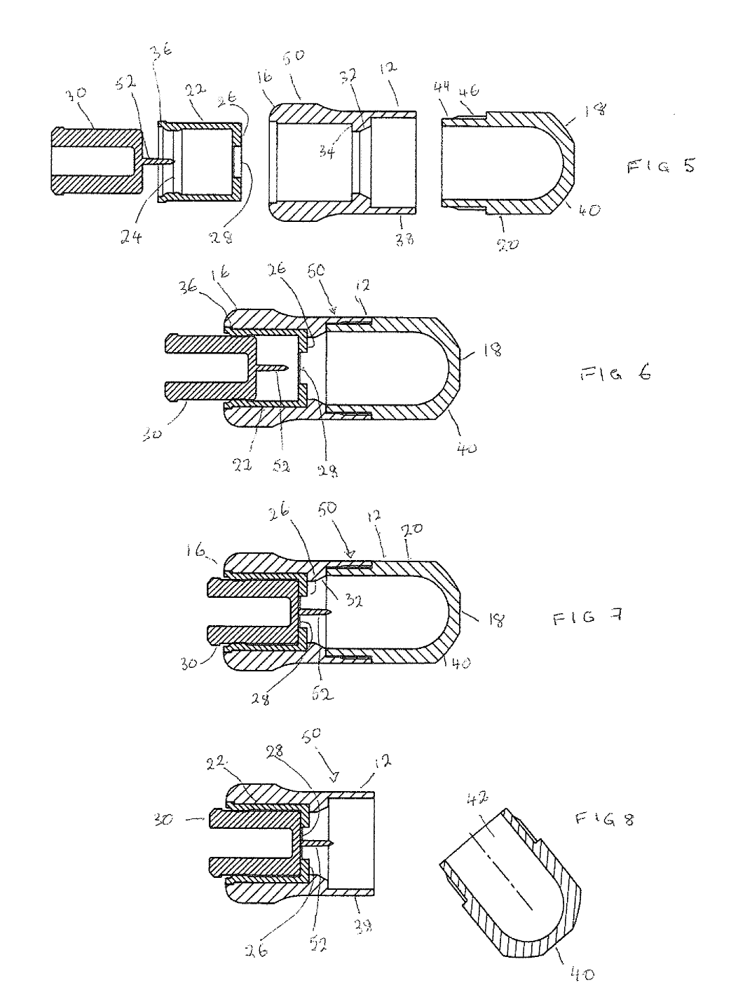

FIG. 5 is a view similar to FIG. 1 showing an alternative embodiment of the container of the present invention;

FIG. 6 is a view similar to FIG. 5 showing the container in assembled condition;

FIG. 7 is a view similar to FIG. 6 showing the container in activated condition; and

FIG. 8 is a view similar to FIG. 7 showing the container in separated condition after activation.

Referring to the Figures, there is shown in FIGS. 1 to 4 of the accompanying drawings, a dental container 10 having an outer central body 12. The outer central body 12 has a proximal end 16 and a distal end 18. A separable nose portion 20 is initially mounted to the distal end 18 of the body 12.

The proximal end 16 is arranged to receive snugly a liquid receptacle 22 having an open outer end 24 and a closed inner end formed by a wall 26. The wall 26 has a relevantly thin weakened central section 28 which is centrally disposed.

Further, the liquid receptacle 22 is arranged to receive at the open outer end 24 thereof a plunger 30 as shown in FIG. 2.

Further the outer central body 12 has an intermediate annular ridge 32 which provides an internally projecting step 34 for engagement with the inner upper end of the liquid receptacle 22 as shown in FIG. 2. Thus, the liquid receptacle 22 is prevented from travelling into the body 12 any further than the ridge 32. In addition the liquid receptacle 22 has an outwardly extending rear circumferential flange 36 which engages with a corresponding recess in the outer central body 12.

Further, it can be seen in FIG. 1 that the distal end 18 of the outer central body 12 has a cylindrical portion 38 arranged to engage with the nose portion 20. The nose portion 20 has an outer wall having a closed outer end 40 and an open inner end 42. Further the wall of the nose portion 20 has a relevantly thin inner portion 44 which engages snugly with the cylindrical portion 38 as shown in FIG. 2 when the container 10 is assembled.

To ensure that the nose portion 20 is firmly engaged with the cylindrical portion 38 the distal end 18 is provided with a circumferential sealing means 46 as can best be seen in FIG. 1.

In operation of the container 10, the liquid receptacle 22 containing liquid is engaged with the proximal end 16 as shown in FIG. 2. Further, the plunger 30 is engaged with the open end 24 in the liquid receptacle 22 as shown in FIG. 2. In this condition the plunger 30 is spaced from the wall 26 of the receptacle 22. Further, the nose portion 20 is engaged with the cylindrical portion 38 to complete the distal end 18 as shown in FIG. 2.

The liquid receptacle 22 contains liquid between the plunger 30 and the wall 26. The distal end 18 contains solid powder material.

The plunger 30 is depressed to the position shown in FIG. 3 and hydraulic pressure from the liquid causes the wall 26 to rupture at the weakened central portion 28. The plunger 30 then pushes the liquid through the ruptured wall 26 into the distal end 18 to contact solid powder contained in the distal end 18.

The container 10 is then placed in a suitable mixing device such as a vibrating mixer of known type. This causes the liquid and powder to become thoroughly admixed to form a paste. The bulk of the paste is contained in the nose portion 20. The nose portion 20 is then manually detached from the body 12 as shown in FIG. 4. The paste can now be manually scooped out using a suitable dental tool for application to a tooth of a patient by the dentist as required.

The container 50 shown in FIGS. 5 to 8 is similar to those shown in FIGS. 1 to 4 and like reference numbers denote like parts. However, in this embodiment of the present invention the plunger 30 is provided with a forwardly extending sharp projection 52. In this case the container operates in similar manner to the container of FIGS. 1 to 4 except that weakened portion 28 of the wall 26 is ruptured by being pierced by the projection 52 rather than by application of hydraulic pressure.

The arrangement of the container of the present invention avoids the need for extruding the paste through an outlet nozzle as is commonly done with less viscous materials.

Modifications and variations as would be apparent to a skilled addressee are deemed to be within the scope of the present invention.

1. A dental container arranged to contain a liquid and a solid powder initially in separated condition comprising an outer central body having a proximal end and a distal end, a liquid receptacle having a closed inner end and an open outer end mounted at the proximal end of the outer central body and a separable nose portion mounted at the distal end of the outer body initially for mixing purposes but which is arranged to be manually separated from the remainder of the container after mixing, a plunger mounted in the open outer end of the liquid receptacle, the closed inner end of the liquid receptacle being formed by a wall having a weakened section, the distal end of the central body and the nose portion being arranged to contain solid powder material, the arrangement being such that depression of the plunger causes the wall of the liquid receptacle to be ruptured at the weakened section so that the liquid and the solid powder material are contacted for mixing together to form a dental paste.

2. A dental container according to claim 1, wherein the nose portion has a closed outer end and an open inner end arranged to engage with the outer central body.

3. A dental container according to claim 2, wherein the outer central body comprises an intermediate annular inwardly extending ridge which provides an internally projecting step for engagement with the inner end of the liquid receptacle so that the liquid receptacle is prevented from moving into the outer central body any further than the ridge.

4. A dental container according to claim 2, wherein the liquid receptacle has an outwardly extending rear circumferential flange which engages with a corresponding inner recess in the outer central body.

5. A dental container according to claim 2, wherein the distal end of the outer central body has a cylindrical portion arranged to engage with the open inner end of the nose portion.

6. A dental container according to claim 2, wherein the distal end of the outer central body has a cylindrical portion arranged to engage with the open inner end of the nose portion and the nose portion has a wall with a relatively thin inner portion arranged to engage snugly with the cylindrical portion of the outer central body.

7. A dental container according to claim 2, wherein the distal end of the outer central body has a cylindrical portion arranged to engage with the open inner end of the nose portion and the distal end of the outer central body is provided with a circumferential sealing means arranged to be engaged with the inner end of the nose portion.

8. A dental container according claim 1, wherein an inner end of the plunger is substantially flat so that upon depression of the plunger liquid in the receptacle applies hydraulic pressure to the weakened section of the inner wall of the liquid receptacle to cause the wall to rupture so that the liquid can contact the solid powder material.

9. A dental container according to claim 1, wherein an inner end of the plunger has a forwardly extending sharp projection arranged to pierce the weakened portion of the wall of the liquid receptacle so that the liquid can contact the solid powder material.
